(19) United States
(12) Patent Application Publication
(10) Pub. No.: US 2025/0235744 A1
(43) Pub. Date: Jul. 24, 2025

(54) System and Method for Enhanced Determination of Club Delivery Parameters

(71) Applicant: TRACKMAN A/S, Hørsholm (DK)

(72) Inventors: Thorsten Svend RASMUSSEN, Værløse (DK); Jesper BRASCH, Kongens Lyngby (DK); Mads Zingenberg MACKEPRANG, Hørsholm (DK); Fredrik TUXEN, Rungsted Kyst (DK)

(21) Appl. No.: 19/033,152

(22) Filed: Jan. 21, 2025

Related U.S. Application Data
(60) Provisional application No. 63/685,068, filed on Aug. 20, 2024.
(60) Provisional application No. 63/623,509, filed on Jan. 22, 2024.

(51) Int. Cl. A63B 24/00; A63B 69/36

(52) U.S. Cl. CPC A63B 24/0021; A63B 69/36; A63B 2220/806

(57) ABSTRACT

A system enhances determination of club delivery parameters and includes an imager capturing a sequence of images of an area in which an impact between a golf club and a ball is to take place, the imager being configured to take a pre-impact series of images from an initial time pre-impact through a time of impact and a post-impact series of images from the time of impact through a final time after the time of impact; and a processor determining ball launch parameters based on a post-impact series of images. The processor performs following operations: identify predetermined characteristic points on the golf club in each of the pre-impact images; determine pre-impact travelling path data for the golf club based on positions of the identified characteristic points in the pre-impact images; and calculate club delivery parameters from a mechanical impact model based on the pre-impact travelling path data.

### PRIORITY CLAIM

The present application claims priority to U.S. Provisional Patent Application Ser. No. 63/623,509 filed Jan. 22, 2024 and U.S. Provisional Patent Application Ser. No. 63/685,068 filed Aug. 20, 2024. The specifications of these applications are incorporated herewith by reference.

### BACKGROUND

Systems have been developed for the tracking of sports balls and for analyzing player motions (e.g., swings, throwing and kicking motions, etc.) to, for example, enhance sports broadcasts and facilitate athlete training, etc. These systems have included various tracking devices such as, for example, radars and imagers, to track and analyze the motion of a ball, the athlete, and/or related items (e.g., rackets, bats, clubs, etc.).

### SUMMARY

The present disclosure relates to a system configured to, in an illustrative embodiment, enhance the determination of club delivery parameters, comprising an imager capturing a sequence of images of an area in which an impact between a golf club and a ball is to take place, the imager being configured to take a pre-impact series of images from an initial time pre-impact through a time of impact and a post-impact series of images from the time of impact through a final time after the time of impact; and a processor configured to determine ball launch parameters based on a post-impact series of images, and is further configured to perform following operations: identify predetermined characteristic points on the golf club in each of the pre-impact images; determine pre-impact travelling path data for the golf club based on positions of the identified characteristic points in the pre-impact images; and calculate club delivery parameters from a mechanical impact model based on the pre-impact travelling path data.

In an embodiment, the processor is configured to apply the ball launch parameters as input to the mechanical impact model when calculating the club delivery parameters.

In an embodiment, the processor is configured to identify, based on, the mechanical impact model, the golf club as one of a driver, a wood, an iron and a wedge.

In an embodiment, the processor is configured to determine a golf club type from the images provided by the imager, and wherein the processor is configured to provide the golf club type as input to the mechanical impact model together with the imager determined characteristics points to enhance the club delivery parameters.

In an embodiment, the system includes a display presenting the club delivery parameters to a system user, wherein the club delivery parameters include at least one of Face Angle, Dynamic Loft, club speed, attack angle and club path.

In an embodiment, the club delivery parameters include at least one of the following Club Speed, Club Path, and Face to Path.

In an embodiment, the processor is configured to extract a first set of characteristic points for the golf club from each image in the pre-impact series of images and apply these data points in a swing model describing a path along which a club head travels towards impact with the ball.

In an embodiment, the processor is configured to extract characteristic points on the golf club based on one of a contour of the club head and a pattern present on a surface of the club head.

In an embodiment, the mechanical impact model used to calculate the club delivery parameters is based on at least one of pre-impact travelling path data for the golf club, the ball launch parameters determined by the processor from the post-impact series of images and a travelling path of the golf club after impact determined by the processor from the post-impact series of images.

In an embodiment, the system further includes a radar system configured to provide position data to the processor for a club head in the series of images captured by the imager, wherein the radar system provides range data to the processor indicating a distance between the radar system and the golf club and/or the ball.

In an embodiment, the radar system provides radial velocity data to the processor indicating radial velocity for the golf club and/or the ball.

In an embodiment, the processor is configured to determine a pre-impact travelling path for the golf club based on the pre-impact series of images and the position data from the radar system for the club head in the pre-impact series of images.

In an embodiment, the processor is configured to determine club delivery parameters based on the pre-impact series of images and the position data from the radar system for the club head in the pre-impact series of images.

In addition, the present disclosure relates to a method for determining golf club delivery parameters, including: capturing a series of images extending for a first predetermined time before an impact between a golf club and a ball through impact between the golf club and the ball for a second predetermined time after the impact between the golf club and the ball; determining ball launch parameters based on the images corresponding to the second predetermined time; identifying characteristic points on the golf club in the images of the pre-impact series of images; determining pre-impact travelling path data for the golf club based the identified characteristic points detected in the pre-impact series of images; and calculating club delivery parameters from a mechanical impact model based on pre-impact travelling path data for the golf club.

In an embodiment, the mechanical impact model uses the ball launch parameters to calculate the club delivery parameters.

In an embodiment, the method further includes identifying, based on the mechanical impact model, the golf club as one of a driver, a wood, an iron and a wedge.

In an embodiment, the method further includes displaying the club delivery parameters to a user and wherein the club delivery parameters include at least one of Face Angle, Dynamic Loft, club speed, attack angle and club path.

In an embodiment, the club delivery parameters include at least one of Club Speed, Club Path, and Face to Path.

In an embodiment, the method further includes extracting a first set of characteristic points on the golf club from at least two images in the pre-impact series of images and applying the first set of characteristic points in a swing model describing a path along which a club head travels toward impact with the ball.

In an embodiment, the method further includes extracting the first set of characteristic points on the golf club based on one of a contour of the club head and a pattern present on a surface of the club head.

In an embodiment, the method further includes calculating the club delivery parameters from the mechanical impact model based on the pre-impact travelling path data for the golf club, the ball launch parameters determined by a processor from a post-impact series of images and the travelling path of the golf club after impact determined by the processor based on the images corresponding to the second predetermined time.

In addition, the present disclosure relates to a processor configured to determine launch parameters of a ball based on a series of images captured by an imager, the processor being configured to perform following operations: detect a golf club in a pre-impact series of images corresponding to a time before impact between the golf club and the ball; identify characteristic points on the golf club in the pre-impact series of images; determine pre-impact travelling path data for the golf club based on the identified characteristic points detected in pre-impact series of images; and calculate club delivery parameters from a mechanical impact model based on the pre-impact travelling path data.

In addition, the present disclosure relates to a system for analyzing an impact between a golf club and a ball, comprising: an imaging system having a field of view including an impact area in which impact between a golf club and a ball is anticipated, the imaging system generating a series of images throughout a time period extending from an initial time at least a first predetermined time before the impact through a final time at least a second predetermined time after the impact; and a processor receiving the images from the imaging system and identifying in a plurality of pre-impact images taken from the initial time to a time of the impact a plurality of characteristic points on a selected portion of the golf club, the processor determining a location of each of the characteristic points in each of the plurality of pre-impact images and calculating a travel path of the selected portion of the golf club based on the locations of the characteristic points in the plurality of pre-impact images, the processor being configured to identify the ball in a plurality of post-impact images taken from the time of the impact through the final time and calculating a plurality of ball launch parameters based on the ball as identified in the plurality of post-impact images.

In an embodiment, the processor is further configured to determine a plurality of club delivery parameters based on the calculated travel path of the selected portion of the golf club.

In an embodiment, the club delivery parameters are calculated based on a mechanical impact model.

In an embodiment, the processor is further configured to identify the ball in at least a first one of the pre-impact images and to determine a pre-impact position of the ball based on a position of the ball in the first pre-impact image, the processor being configured to calculate the club delivery parameters based on a comparison of the pre-impact position of the ball and the calculated travel path of the selected portion of the golf club.

In an embodiment, the processor is configured to calculate the club delivery parameters based on the ball launch parameters.

In an embodiment, the processor is configured to determine a 3D spin axis of the ball based on a dense optical flow calculated by comparing the positions in sequential ones of the post-impact images of selected points on a surface of the ball.

In an embodiment, the imaging system includes only a single imager.

In an embodiment, the processor is configured to determine a location of each of the characteristic points in at least two of the post-impact images to calculate a momentum of the golf club after impact with the ball.

### BRIEF DESCRIPTION OF DRAWINGS

FIG. 1 shows an exemplary system according to the present disclosure.

FIG. 2 shows a side view of an exemplary system measuring various aspects of a golf ball and a golf club during a swing.

FIG. 3 illustrates a method according to one aspect of the present disclosure for determining a pre-impact travelling path for a golf club.

FIG. 4 illustrates how a sequence of images is divided in an exemplary method into a pre-impact sequence and a post-impact sequence of images.

FIG. 5a illustrates an exemplary club head and shaft illustrating parts of the club head and shaft relevant to the analysis of the motion of a golf club according to an exemplary method.

FIG. 5b illustrates an exemplary head of a driver and shaft relevant to the method described in regard to FIG. 5a.

FIG. 6 shows characteristic features of the club head of FIG. 5 identified by a localizer program analyzing motion of the club head in accord with a first embodiment of the present disclosure.

FIG. 7 shows characteristic features identified by a localizer program analyzing an exemplary club head according to a second embodiment of the present disclosure.

FIG. 8 illustrates one embodiment of the localizer program on the computer.

FIG. 9 illustrates how data entering a first exemplary swing model may describe the traveling path of the club head towards the ball.

FIG. 10 illustrates how data entering a second exemplary swing model may describe the traveling path of the club head towards the ball.

FIG. 11 illustrates a flowchart for the method of enhancing determination of club delivery parameters according to one embodiment of the present disclosure.

FIG. 12 shows a further exemplary system according to the present disclosure.

FIG. 13 shows an exemplary spectrogram of a radar signature from a time immediately before a golf club impacts the ball through a post impact time.

FIG. 14 shows a graphical representation of the spectrogram of FIG. 13.

### DETAILED DESCRIPTION

The exemplary embodiments may be further understood with reference to the following description and the related appended drawings, wherein like elements are provided with the same reference numerals. The exemplary embodiments relate to systems and methods for parameter determinations for sports game applications. In particular, these detections and/or determinations can be performed using image processing techniques on a sequence of images, from an imaging system (e.g., from a single imager or a plurality of imagers).

In one embodiment, one or more imagers of the imaging system can operate in more than one mode. For example, one or more of the imagers may operate, at certain times, in a low-power state while, at other times, the imager will operate in a high-power state. In the high-power state, the imager may generate a number of frames per second higher than a number of frames per second in the low-power state (a higher frame rate in the high-power state), the resolution of the imager may be increased in the high-power state relative to the low-power state, and/or other operating parameters suitable for the derivation of certain parameters may monitor these parameters in an more intensive way under selected conditions while operating at a lower level (e.g., a more power and resource efficient manner) when the selected conditions are not present.

In one illustrative embodiment, the system moves the imager into the high-power state when conditions are detected indicating that the user is beginning a swing that will result in a ball strike so that the imager can capture images suitable for the derivation of impact and/or launch parameters of a sports ball, and club delivery parameters as will be described in more detail below. At times other than when such a swing is detected, the system can operate in the low-power state so that the system can conserve resources (e.g., battery power) while continuing to monitor the environment to determine when the selected conditions for initiating the high-power state are present. In one exemplary aspect, the system is configured to capture data enabling the measurement of a three-dimensional (3D) spin axis of the sports ball (e.g., a golf ball).

In certain illustrative embodiments a single imager is used to capture a sequence of images (although, as would be understood by those skilled in the art, multiple imagers may be used to generate one or more sequences of images for use in these analyses) that may be processed by a computing device in a variety of operations including, for example: object detection; object tracking; event detection; state detection; parameter determinations; etc. These operations will be referred to herein collectively as “detections” or “determinations.” These various operations require different image capture parameters and associated processing burdens for performing the detection or determination. In one non-limiting example, certain detections may require a high frame rate while others may be performed with a low frame rate. Similarly, different resolutions or lighting conditions may be necessary or appropriate for different types of detections. Some detections may impose a high processing burden on the computing device while others may impose a relatively low processing burden.

Various types of detections related to the game of golf, e.g., object detections, state detections, or event detections, that can be performed based on a sequence of images (or a single image) from, e.g., a single imager, include, for example: ball detection; ball motion tracking; club detection (including identifying a type of club in use); club motion tracking (including identification of different aspects of a swing progression, e.g., backswing, downswing, etc.); detection of a type of swing (e.g., putt, chip shot, flop shot, full swing, half swing, etc.); detection of impact between the club and the ball; determination of an impact location on the club; etc.

Various parameters related to the game of golf that can be determined based on a sequence of images (or a single image) from, e.g., a single imager, include, for example: determination of an initial speed for a struck ball; identification of an initial direction of travel for a struck ball; club parameters such as an attack angle, dynamic loft, dynamic lie, club path, club speed, and face angle; a distance from the imager to the ball; etc.

Various image capture parameters relevant to the acquisition of a sequence of images (or a single image) from an imager include, for example: a frame rate; resolution of the images; zoom; lighting conditions; the range of wavelength represented in the image (e.g., visible spectrum, infrared spectrum, etc.); identification of a region of interest (ROI) within the image (e.g., a portion of the image including the ball); position and orientation of the imager; etc. It is noted that some imagers have capabilities different from those of other imagers, e.g., some imagers may be capable of image capture at a higher frame rate or resolution than others, and some imagers have adjustable image capture parameters, e.g., variable frame rate or resolution (up to a maximum).

Some detections/determinations related to the game of golf are preferably or necessarily performed with certain image capture parameters, e.g., with the imager operating at minimum operating parameters necessary to capture images that allow the derivation of the desired parameters (or at parameters above these minimums), while other detections and/or determinations can be performed with more relaxed image capture parameters (i.e., at parameters below the minimum levels required for the other detections/determinations). In one illustrative example, the determination of impact parameters for a golf club is performed by capturing a number of images for a time period beginning immediately prior to impact between the ball and the club and ending either at or prior to impact, for a time period beginning at or immediately after impact, or extending through impact from a time prior to impact and extending through a predetermined time period subsequent to the impact—including, for example, one or more images as near to the time of impact as possible.

In another illustrative example, the determination of launch parameters for the ball is performed by capturing a number of images extending from the time of impact or a time immediately after impact to a predetermined time after impact. Depending on a desired level of accuracy, due to the relatively high speed of the club and the ball at impact, the imager should capture these images at a relatively high frame rate (e.g., the imager is operating in a high-power state) to provide to a computing device a number of images sufficient to allow for the determination of the selected impact parameters. Conversely, in another example, the detection of certain events related to the swing (e.g., a backswing) may require fewer images (e.g., only two or three) captured at a relatively low frame rate (i.e., the imager may operate in the low-power state).

Relatedly, different image capture parameters, types of detections and types of determinations may impose different requirements on the imager and/or the computing device processing the image data. These different imager settings and associated processes also lead to differences in power consumption. In one illustrative example, higher frame rates, resolutions, lighting conditions, etc., for the imager entail higher processing burdens and power consumption than lower frame rates, resolutions, lighting conditions, etc. In another illustrative example, some object detection algorithms (ball detections, club detections) may be run continuously on every image acquired by the imager without imposing a high processing burden while in still another illustrative example, the detection of impact parameters will impose a significant processing burden due to the complexity of the calculations required.

U.S. Pat. No. 10,953,303 describes systems and methods for determining impact characteristics of a sports ball with a sport ball striking element based on images, e.g., from a single imager, and is hereby incorporated by reference in its entirety. U.S. Pat. No. 11,452,911 describes systems and methods for determining launch characteristics of a sports ball based on images from, e.g., a single imager and is hereby incorporated by reference in its entirety.

A system (including at least an imager and an associated computing device) can be selected for use based on the types of detections/determinations which the system is intended to perform. Some systems or system components may have limited imager capabilities and/or processing capabilities and may be used for simpler detections/determinations, while others may have advanced imager capabilities and/or processing capabilities and may be used for more complex detections/determinations. In one illustrative example, an advanced imaging and processing apparatus is used to determine impact parameters while a simpler imaging and processing apparatus, or the same imaging device operated in a less data intensive manner, is used to analyze swing motion. In another illustrative example, a particular position and orientation of the imager is preferred or required to permit the imager to capture images suitable for the intended data intensive detection/determination.

It should be understood that, when an advanced imaging/processing system is implemented, the system need not continuously run at its highest level. For example, if a system is intended for the determination/detection of a variety of different parameters, events or states, the operating parameters of the system can be manually or automatically adjusted depending on current needs. Some image processing algorithms can be run continuously or semi-continuously, while others are run only occasionally. As described above, some image capture parameters/settings are appropriate for certain detections/determinations, while other image capture parameters/settings are appropriate for other detections/determinations.

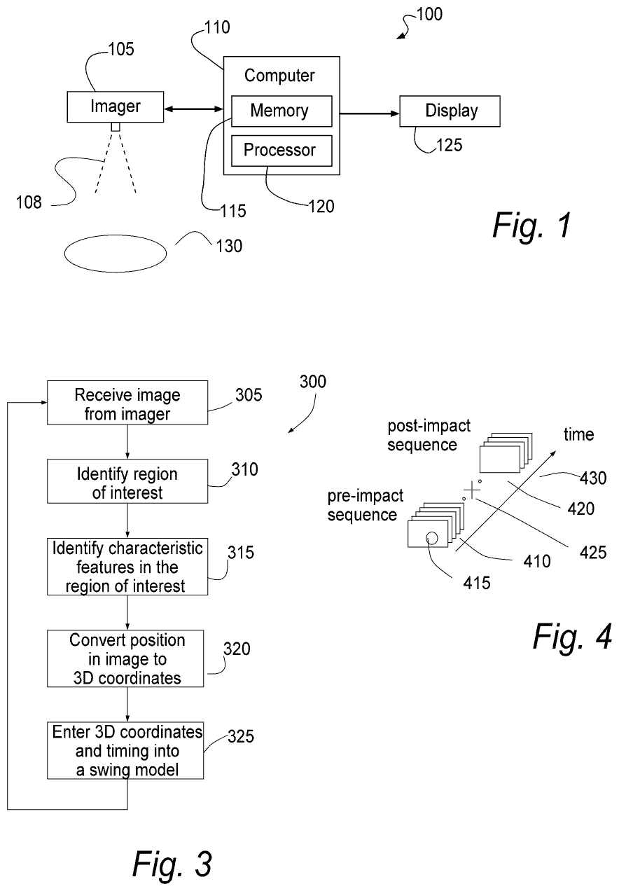

FIG. 1 shows a system 100 according to an exemplary embodiment of the present disclosure. The system 100 includes an imager 105, a computer 110 comprising a memory 115, a processor 120, and a display 125. The system 100 may be implemented in a variety of different settings. In one illustrative example, one or more components of the system 100 is mounted on a ceiling or some other structure at a height above the scene to be viewed with the imager 105 orientated so that its field of view (FOV) 108 is facing downward at the scene area 130. In these embodiments, the system 100 may be implemented, e.g., at a driving range or in an indoor golf setting such as a golf simulator. However, the exemplary embodiments are not limited to this arrangement.

As will be described in further detail below, the system 100 may be tailored to different golf settings, e.g., with the imager 105 in different positions/orientations, or other sports settings or movable to different positions during use, e.g., to capture different actions during a sporting event. Additionally, in some scenarios, the system 100 may include additional sensors configured to capture parameters in addition to those captured by the imager 105, or to capture the same parameters, e.g., to enhance accuracy or to provide redundancy to account for instances where the imager fails to capture all of the required data.

The imager 105 of this embodiment is configured to capture image data (images or frames) of a scene within its field of view (FOV) 108 including a launch location for a golf ball and the area immediately in front of the launch location. The imager 105 can be configured for different operational settings, e.g., frame rate, resolution, zoom, crop, etc. The imager 105 in these embodiments is selected to have a maximum frame rate sufficiently high to capture multiple images of golf club moving toward impact and a ball in flight as the ball traverses the view FOV 108, e.g., greater than 100 frames per second (fps). However, the imager 105 can also be configured to capture images at a lower frame rate or the system may include a first imager capturing images of a region of interest at a first, high frame rate and/or resolution and a second imager capturing images of the region of interest at a second, lower frame rate and/or resolution, etc.

The imager 105 may have a global shutter capturing the entire image at once, which results in undistorted images even when capturing fast-moving objects, where the entire image or a cropped portion thereof is transferred to the computer 110.

In another embodiment, the imager 105 may have a rolling shutter, e.g., capturing image data one line (of pixels) at a time in a pattern that moves sequentially across a light-sensitive chip of the imager 105. In such a case, the imager 105 is preferably oriented so that a direction across the imager in which the pixels are exposed through the rolling shutter (i.e., a direction from a first line of pixels to be exposed to the next line of pixels to be exposed, etc.) is the same as an expected direction of movement of the ball across the field of view of the imager 105. At high frame rates, when using an electronic rolling shutter, the image sensor can continue to gather photons during the acquisition process, thus effectively increasing sensitivity. The effect is most noticeable when imaging extreme conditions of motion or the fast flashing of light.

The imager 105 may be configured to operate in a selected wavelength band. For example, the imager 105 may operate in the visual spectrum, the infrared spectrum, or the near-infrared spectrum. For indoor settings, the field of view of the imager 105 may be lighted by one or more light sources (not shown) to achieve the desired quality of the images as would be understood by those skilled in the art.

In some aspects, the computer 110 may be integral with the imager 105 or the computer 110 may comprise a separate processing apparatus. The computer 110 may be connected to the imager 105 by a wired or wireless connection and may comprise one or more different computer devices dividing up the data processing in any desired manner as would be understood by those skilled in the art. For example, the imager 105 and the computer 110 may include respective transceivers (not shown) for sending and receiving data, as would be understood by those skilled in the art. The computer 110 may store computer-readable data in the memory 115 for execution by the processor 120. For example, the memory 115 may contain various image processing algorithms such as, e.g., back swing of golf club detection; ball detection; object detection; event detection; deep learning (DL) models; dense optical flow (DOF) models; pre-processing; post-processing; etc., to be described in greater detail below. The results of the analyses, e.g., parameter determinations, can be presented to a user by the display 125. For example, the spin parameters for a launched ball can be displayed by the display 125.

In some aspects, the computer 110 may transmit commands to the imager 105 to adjust the operational state of the imager 105, or to crop the image to contain only a region of interest ROI (e.g., to reduce computational demands). For example, based on the output of some image processing algorithms executed on the stream of images from the imager 105, the computer 110 can determine an event is upcoming and transition the imager 105 into a high-power state, e.g., for the capture of launch parameters. When this event has been observed as required, the computer 110 may then transmit commands to the imager 105 to adjust the operational state of the imager back to the low-power state.

In this embodiment, in the low-power state, the imager 105 provides to the computer 110 a continuous stream of images at a low framerate (e.g., 1-100 images per second) and/or, alternatively, at a resolution lower than that of the images generated in the high-power state. In this low-power state, the computer 110 continuously or semi-continuously executes one or more object detection algorithms for each frame received from the imager 105. The processor 120 detects relevant objects in the scene using an object detector suitable for that purpose and stores the information in the memory 115. The object detection algorithms can include, e.g., a ball detector and a club detector as would be understood by those skilled in the art.

Various types of object detectors of varying complexity may be used according to the present embodiments. For example, in some applications, where high precision is desired (e.g., for a ball detection algorithm) pixel locations defining the portion of the image corresponding to the ball can be precisely determined. In other examples, high precision may not be necessary or useful for the ball detection algorithm. Object detectors such as, e.g., YoloV3 or Faster-RCNN, are commonly used within computer vision and/or AI/deep learning applications. As would be understood by those skilled in the art, object detectors can be designed by those skilled in the art to detect particular types of objects on which the object detector is trained, e.g., with training data having detailed annotations. The object detectors can either be created from scratch or by retraining already available models.

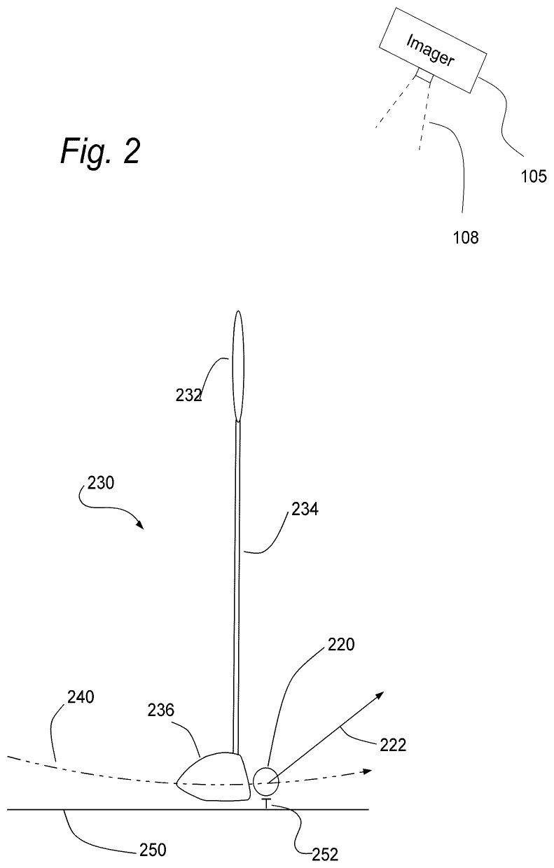

In some aspects of these exemplary embodiments, an exemplary system measures various parameters related to a golf ball and a golf club during a swing. FIG. 2 shows an exemplary system measuring various aspects of a ball 220 (e.g., a golf ball) and a club 230 (e.g., a golf club) during a swing. The imager 105 is mounted on a ceiling or some other structure at a height above the scene to be viewed with the imager 105 orientated so that its field of view (FOV) 108 is facing downward at the scene area 130. The imager 105 of this embodiment uses high speed camera technology to measure various parameters related to the ball 220 prior to and during impact as well as during an initial portion of its flight and the club 230 during a swing. In the illustrated embodiment, the imager 105 is mounted above (e.g., 3 meters+/−1 meter) the scene area 130 and in the flight direction (e.g., 1-3 meters in front of the ball 220 in horizontal direction) of the ball 220 when hit.

The club 230 in this example is a driver which is usually used in a first shot made to strike a ball mounted on a tee in an area called the tee box. The club 230 comprises a shaft 234 (e.g., a golf club shaft), a club head 236, and a grip or handle 232. When a (not shown) golfer swings the club 230, the club head 236 moves along a substantially circular path (illustrated by an arc segment 240) towards impact with the ball 220. The ball 220 may rest on the ground, or as shown in this example, atop a tee 252 which is a small peg for lifting the ball 220 above ground 250. As a result of the impact with the club head 236, the ball 220 will leave the tee box in a direction marked with an arrow 222. The club head 236 comprises a face and a body configured for optimizing launch conditions and flight of the ball after impact.

Upon detection of a backswing of the club 230, the imager 105 enters a high-speed data acquisition mode (i.e., the high-power state), in which the imager 105 provides to the computer 110 a continuous stream of images at a high framerate and/or images of a higher resolution. The images delivered to the computer 110 may be cropped parts of the image picked up by the imager 105 (i.e., cropped to exclude areas outside the region of interest (ROI)). The means that, in this embodiment, only the ROI is included in each of the images delivered to computer 110. Thus, the frame rate is maintained, but the size of the image being analyzed by the computer 110 is reduced, saving bandwidth and processing power.

This stream of images at a high framerate is illustrated in FIG. 4 and may be seen as a pre-impact sequence 410 of images and a post-impact sequence 420 of images, divided by a few images (e.g., a post-impact sequence of images 425) showing the actual impact between the club 230 and the ball 220. When the imager 105 hands over a frame or an image to the computer 110 timing information will be included, which is illustrated by the timeline 430 along the sequence of images. Furthermore, a region of interest ROI 415 is marked in the image. The region of interest ROI 415 in this embodiment contains the portion of each image showing the impact between the club 230 and the ball 220, at least a part of the path of the club head 236 before impact, and at least parts of the paths of the club head 236 and the ball 220 after impact.

Several types of golf clubs are commercially available, and the most common types will be described briefly. Drivers are designed for long-distance shots and are typically used for tee shots. The driver is the most common type of wood and has the lowest loft of any club. Fairway woods are also used for long-distance shots from the fairway. Irons are another type of club and are used for shorter shots e.g., when approaching the green. Irons are numbered from 1 to 9, with the lowest number having less loft and longer shafts. Wedges are used for short shots around the green and are designed to launch the ball in a steep curve, e.g., from a bunker. Putters are used on the green and are designed to roll the ball into the hole.

Golf clubs, such as irons and wedges, have grooves on the club face. These grooves are generally parallel recessed lines on the face of a golf club configured to improve the golfer's ability to generate backspin which helps in controlling the trajectory of their shots. Furthermore, the grooves allow water and debris to exit the impact zone and allow for better connection between the ball and the club. These grooves may have different shapes in regard to the face of the golf club. The two most common types of grooves are U- and V-shaped grooves (i.e., the grooves when viewed in a cross-section of the club perpendicular to the club face are shaped as a U or a V). The grooves in the wedges and irons generally serve two purposes.

First, they increase the frictional engagement between the club face and the ball, enhancing the ability of the golfer to impart spin to the ball. Secondly, the grooves are generally oriented and positioned on the club face so that a golfer looking at the club face can identify a sweet spot 502 at which it is desired to impact the ball. For example, this sweet spot 502 may be a point on a club face 510 aligned with a center of gravity of a club head 500. The face 510 of a driver or other wood will generally not be grooved to enhance frictional engagement with the ball. However, the face 510 of a wood will almost always include markings similar in pattern to the grooves on wedges and irons configured to enable the golfer to visually identify the sweet spot 502 on the face 510 of the driver. Similarly, some putters also have markings similar to the groove-like markings on woods or other markings that help a golfer visually identify a sweet spot 502. The system may analyze such putters in the same manner as woods to identify the sweet spot 502 indicated by the markings.

For both the grooves on irons/wedges and the groove-like markings on woods, the sweet spot 502 on the club face is generally on a line connecting the center points of the grooves or groove-like markings. As will be described in more detail below, the system analyzes images to identify these grooves and groove-like markings and identifies the sweet spot on the club face as the intersection between the line connecting the center points of the grooves or groove-like markings with a selected line parallel to the grooves or groove-like markings. This line parallel to the grooves or groove-like markings is generally selected to be midway between a sole and a crown of a club head. For example, this line midway between the sole and the crown of an iron may be the fifth groove above the sole of the club face. In this case, the sweet spot on the club face may be identified as the intersection of this fifth groove and the vertical line connecting the center points of the grooves.

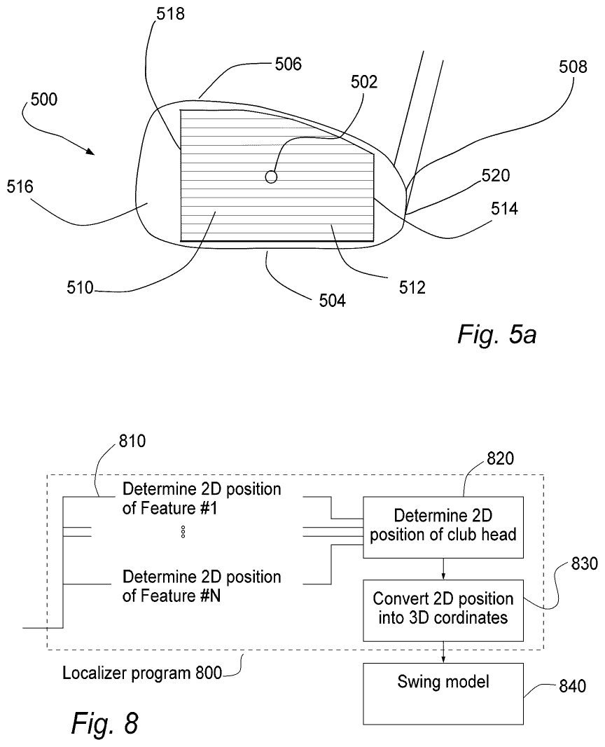

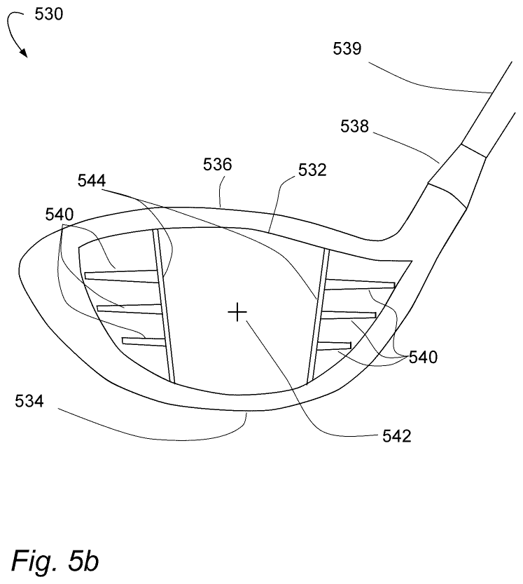

FIG. 5a illustrates the head 500 (e.g., a club head of an iron). The relevant parts of the head 500 are the face 510, a sole 504, a crown 506, and a hosel 508. Each of these parts can have different shapes, sizes, materials, and designs that affect the performance and feel of the head 500. The face 510 is the part of the head 500 that strikes the golf ball and determines the launch angle, spin rate, and ball speed. The face 510 has several grooves 512 configured to optimize ball launch conditions (e.g., ball spin, providing a path for the removal of water, debris, etc. to move out of the space between the ball and the face 510, etc.) and to facilitate identification by the golfer of the location on the face 510 at which it is most desirable to impact the ball.

The sole 504 is the part closest to the ground and affects the club's interaction with the turf. The head 500 has a sweet spot 502 on the face 510 aligned with a Center of Gravity (CoG) of the head 500 that is moving towards the ball 220 prior to impact. The crown 506 is the top part of the head 500 and influences the club's aerodynamics and weight distribution. The hosel 508 is the part that connects the head 500 to the shaft 234 setting a loft angle, etc. which, along with the golfer's swing mechanics, will influence the face angle and the attack angle (e.g., at the moment of impact). The golf club has a toe 516, which is the outer end of the head 500 (e.g., the part of the head 500 farthest from the heel 520), and a heel 520, which is the part of the head 500 furthest from the toe 516.

As seen in FIG. 5a, the grooves 512 extend across the face 510 generally parallel to the sole 504 from a first line 514 adjacent to the heel 520 to a second line 518 adjacent to the toe 516. Thus, the center point of each of the grooves 512 can be identified as a point on the groove 512 midway between the lines. 514 and 518. Thus, even if some or all of the grooves 512 are not visible in any of the images, the line connecting the center points of the grooves 512 can be identified as a line midway between the first and second lines 514 and 518 and parallel to these lines. Of course, as would be understood by those skilled in the art, if the grooves 512 (or groove-like markings) are not visible in the images, the system may identify the sweet spot 502 by finding a spot midway between the sole 504 and the crown 506 and midway between the toe 516 and the heel 520. Thus, this system is able to identify the sweet spot 502 without requiring additional markers on the club as are needed in many currently available systems. However, if such markers are present, the system can identify the markers and, using a priori knowledge concerning the geometric relation between the markers' locations and the sweet spot 502, the system may even more accurately determine the location of the sweet spot 502. Alternatively, if a priori knowledge concerning the relation between the locations of the markers and the sweet spot 502, the system may track the movement of the markers relative to other fixed points on the club (e.g., the hosel 508, the toe 516, etc.) through multiple images using the markers as additional identifiable fixed locations on the club to more accurately determine the location of the sweet spot 502.

In addition, as would be understood by those skilled in the art, by identifying the grooves 512 or otherwise identifying one or more lines parallel to the grooves 512, the system may also compare the orientation of these lines over time to a horizontal and/or to the orientation of a surface on which the ball is resting to determine a lie of the club. In addition, this same method could be used to determine the sweet spot for putters or any other club that has no grooves or groove-like markings.

Similarly, FIG. 5b illustrates a head 530 of a wood such as a driver. The relevant parts of the head 530 are a club face 532, a sole 534, a crown 536, and a hosel 538 at the base of a shaft 539 to couple the head 530 to the shaft 539. Each of these parts can have different shapes, sizes, materials, and designs that affect the performance and feel of the head 530. As indicated above, the face 532 is the part of the head 530 that strikes the golf ball and determines the launch angle, spin rate, and ball speed. For woods, such as the driver shown in FIG. 5b, the face 532 often will not have grooves but will have several groove-like markings 540 configured to visually indicate to the golfer the sweet spot 542. In the case of the face 532, the sweet spot 542 is indicated as a point in the center of the middle one of the groove-like markings 540. As can be seen in FIG. 5b, the groove like markings 540 do not extend across a central part of the face 532 but end at lines 544. There may be any number of different patterns made for the markings on the face 532 of a wood but they will always visually indicate to a golfer where the sweet spot 542 is located and the system can process these markings in the same manner to locate the sweet spot 542 as described above. In other respects, the movement of the head 530 may be analyzed in a manner substantially identical to that described above in regard to the head 500.

FIG. 3 illustrates a method according to one aspect of the present disclosure for determining a pre-impact travelling path for a club 230 (e.g., a golf club). In step 305, a current image is received in the computer 110 from the imager 105. An image processing algorithm running in the processor 120 identifies the region of interest ROI 415 in the received image. For the pre-impact sequence 410 of images, the region of interest ROI 415 contains the head of the club 230 moving towards the ball 220. The club 230 is identified, in this embodiment, based on the shape of the elements detected in the image as well as knowledge about the position of the region of interest ROI 415 in a previous image of the image sequence. In step 310, objects within the region of interest ROI 415 of the current image are identified. For example, the object may be the club head 236, and image data showing the contour of the club head 236 and characteristic visual elements, such as the grooves of the face of the club head 236, are input to a localizer program 800 which is schematically shown in FIG. 8.

In step 315, the localizer program 800 identifies a number of characteristic features of the club 230 from the current image, and their position in the 2D image. For this purpose, the localizer program 800 may include an object detector 810 having some modules (e.g., AI modules) specifically trained to recognize the contour of the club head 236 and characteristic visual elements, such as the grooves of the face of the club head 236. The characteristic features are identified by the object detector 810 with AI modules and a measure for the quality of the identification is transferred to a 2D position determination module 820. In step 320, the determined 2D coordinates for the characteristic features are converted into 3D coordinates in a 2D to 3D converter module 830 of the localizer program 800.

The converter module 830 may, e.g., have been calibrated when mounted. The calibration may include computing a 3D direction vector of a ray corresponding to a given 2D image point by inverting the camera projection model. Computing the 3D direction of the vector of this ray in the coordinate frame attached to a grid, using the relative pose between the camera and the grid, and finding a desired 3D point by computing the intersection between the 3D ray and the grid plane. As would be understood by those skilled in the art, other methods also exist for determining 3D coordinates based on one or more 2D images. For example, the calibration module may compute 3D coordinates by incorporating with the data from the 2D images data from a radar giving range or range rate to the ball (where the radar and imager are calibrated so that data from the radar can be converted into a coordinate system in common with that of the camera or vice versa). In addition, where a 3D radar system is employed the radar data may also be used to provide data regarding the angular position of points on the club and ball in a coordinate system calibrated to that of the camera. As would be understood by those skilled in the art, knowing the angular orientation of a common point with respect to a camera and a radar as well as a range from the radar enables the system to determine a 3D position of the common point. Thus, image data pre and post-impact may be combined with pre and post-impact radar data time synchronized to this image data to determine 3D location and orientation over time of the club head while the image data may be used to determine the location of the ball pre and post-impact while the radar data may be used alone or in conjunction with the image data to determine the location of the ball post-impact. In addition, based on the imager data alone, the system may determine the spin rate of the ball and identify a 3D spin axis.

Those skilled in the art will understand, therefore, that the system may generate accurate data tracking the 3D position and orientation of the club up to and through impact as well as the trajectory and spin of the ball (to accurately estimate a full flight path of the ball) based on image data alone. The accuracy of this data may also be enhanced by the optional addition of radar tracking as described above. Alternatively, or in addition to the use of radar tracking, calculations of the 3D positions may be made by combining the 2D image data with an Impact Model based on the physics relating to collisions such as the collision between a golf club and a golf ball as will be described in more detail below. Thus, the use of radar tracking data and/or an impact model can enhance the accuracy of the club and ball data as compared to the results in using 2D images alone.

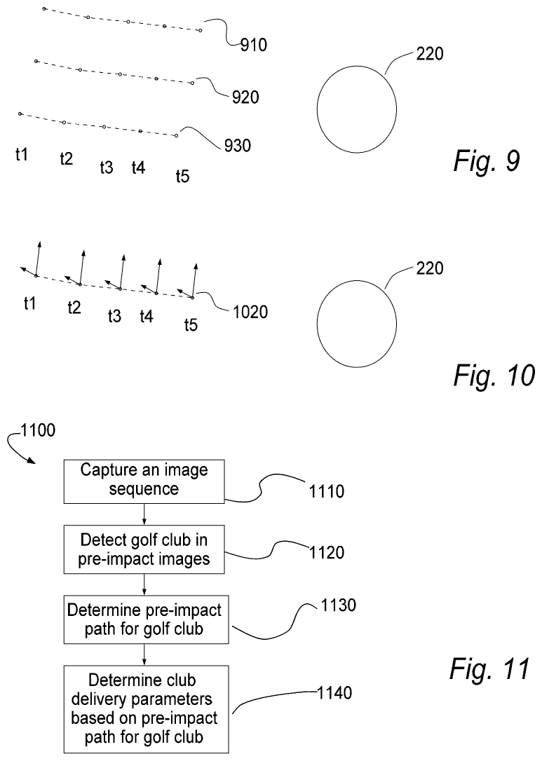

Once the 3D coordinates have been determined, the data for the frame or the image is entered in step 325 into a swing model (a computer program on computer 110 for modelling the club head path) together with timing information for the frame or the image. The localizer program 800 repeats steps 305 to 325 for each subsequent frame or image captured by the imager 105 until the club has impacted the ball 220. The swing model 840 models a traveling path for the golf club head based on the positions of a plurality of discrete data points in the images as shown in FIGS. 9 and 10. The data from the localizer program 800 may be transferred to the swing model 840 after each frame, or as a batch after completion of the analysis of all of the images in the pre-impact sequence 410.

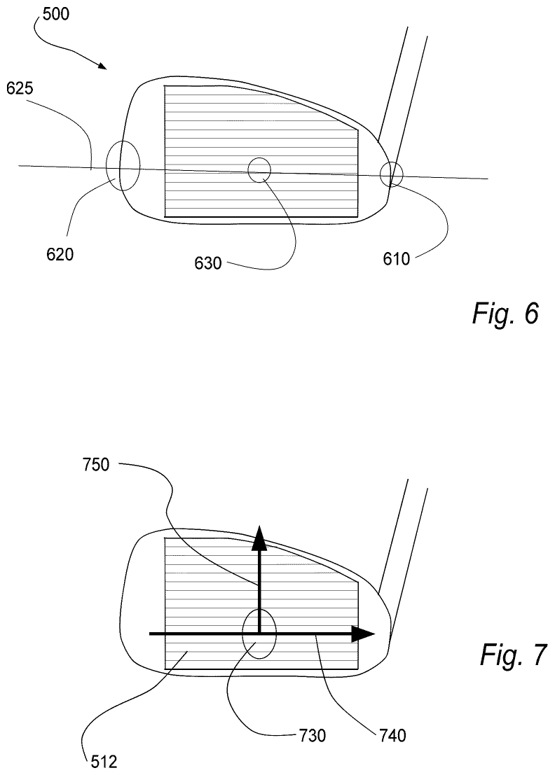

When the contour of the club 230 is available, the localizer program 800 may detect a maximum width of the contour, and thereby as shown in FIG. 6 identify a hozel point 610 and a toe point 620. A midpoint on a line 625 passing through the hozel point 610 and the toe point 620 may be denoted as a center point 630. The localizer program 800 can do this for any golf club type, as this is just a matter of identifying the maximum width of the club's head contour. The center point 630 may be found by the AI module or by dividing in half the line 625 passing through the hozel point 610 and the toe point 620. The swing model will collect data as illustrated in FIG. 9, so that the determined 3D locations for the hozel point 610, the center point 630, and the toe point 620 may be used to draw the curves 910, 920, and 930, respectively. In this embodiment, the hozel point 610, the center point 630, and the toe point 620 data is plotted for five successive frames at times, t1-t5.

As indicated above, when dealing with club types such as irons or wedges, the face 510 will have a number of horizontal grooves 512. The localizer program 800 may, for example, detect a specific groove 512, e.g., the fourth groove counting upward from the heel of the head 500 and find a center point 730 for this groove 512. as shown in FIGS. 6 and 7, the groove 512 in this exemplary club defines a straight line which may serve enable the localizer program 800 to define a face vector or line 740. A cross vector 750 orthogonal to the face vector 740 is also determined by the localizer program 800. The cross vector 750 and the face vector 740 may then be used by the localizer program 800 to define the plane of the face 510. For each frame or image, the center point 730, the cross vector 750, and the face vector 740 are transferred to the swing model. The swing model will collect data as illustrated in FIG. 10, where the positions of the center point 730 illustrate the path of the head 500 travelling towards the point at which the head 500 will impact the ball 220, while the cross vector 750 and the face vector 740 illustrate the orientation of the head 500 in 3D space. This may be used to draw the curve 1020 plotted for five successive frames at times, t1-t5.

Depending on the frame rate, the traveling path of the club head and the field of view of the imager, the curve 1020 may consist of a data set from multiple frames or images in the pre-impact sequence 410, which may include as few as 2 images or may include one hundred images or more. For example, the club speed may vary from approximately 2 miles per hour (0.9 m/s) up to 120 mph or even, for long drivers, to speeds up to 160 miles per hour (71.5 m/s). The camera will typically be seeing the club prior to impact for 0.3-0.6 m. This means that the minimum time clubhead will be in field of view of the camera prior to impact is about 4.2 ms. As the framerate for a camera according to these embodiments will be running between 1000-4000 fps, such a system will capture at least 4 frames during this time period even for the highest club speed. However, as indicated above, although capturing a greater number of frames may enable the system to enhance the accuracy of calculations, only 2 frames are required to make the required determinations of club and ball movement as well as ball spin.

From the post-impact sequence of images 425, the system 100 may track the launched ball 220 as disclosed in U.S. patent application Ser. Nos. 18/334,730, 18/334,685, and 18/334,764, all filed by the assignee Jun. 14, 2023. These applications are hereby incorporated by reference in their entireties. The process of analyzing the post-impact sequence of images 425 in order to determine ball data has been implemented in Trackman iO, these ball data include Ball Speed, Launch Angle, Launch Direction, Spin Rate, Spin Axis, Hang Time, Height, Curve, Landing Angle, Carry, Side, Total, and Side Total. In analyzing the post-impact sequence of images 425, the processor 120 will observe two moving objects, namely the club head 236 and the ball 220. The club head 236 is tracked after impact in the same manner explained above. A set of data points similar to those described above are generated based on a sequence of post-impact images and these data points are used to create a post-impact golf club path model in the same manner described above for the pre-impact (swing) model of the golf club path.

Due to the law of conservation of momentum, having a good estimate of the launch parameters for the ball, the travelling path of the golf club prior to impact, and the travelling path of the golf club after impact, the system more accurately calculates club delivery parameters including at least one of the following: Club Speed, Club Path, and Face to Path. As those skilled in the art would understand, the conservation of momentum in this situation where the ball is at rest before impact can be described by the equation:

$${m}_{club} {v}_{p r e - impact} = {m}_{club} {v}_{post - impact} + {m}_{ball} {v}_{post - impact}$$

where m is the mass and v is the velocity.

An exemplary system as described herein can expect to obtain at least 4 frames showing the club head before impact and 8 frames of the ball post impact. As indicated above, this number of frames can enhance the accuracy of the required calculations, but good results can be obtained with as few as 2 pre-impact and 2 post-impact frames.

The object detector 810 detects and localizes relevant objects including, for example, the ball 220 and the club 230 visible in the image being processed. In some embodiments, the launch parameters to be determined for the ball 220 include spin parameters such as a 3D (three dimensional) spin rate and spin axis. Current techniques for analyzing ball motion in sports that use a single imager 105 are typically limited to measuring a velocity vector and speed of a moving ball. According to the present techniques to be described in detail below, a system can retrieve the full 3D rotation vector of a sports ball shot (e.g., a golf shot) using only a few images acquired by the single imager 105. In one embodiment, a full 3D rotation vector of a moving spinning spherical sports ball is measured using only images acquired by the single imager 105.

According to the present disclosure, the 3D Spin Axis (SA) of a moving ball is calculated by observing only a small part of a shot trajectory, e.g., a portion of the trajectory immediately following the launch of the sports ball. The method according to this embodiment, uses as the imager 105 a camera having a high frame rate (e.g., 1,000 to 4,000 fps in the high-power state) so that, in the time immediately after launch the system will obtain at least 8 frames showing the movement and rotation of the ball in flight. However, as indicated above, accurate results can be obtained with as few as 2 frames showing the ball post-impact. That is, although this method determines the parameters of the flight of the sports ball only within a short period after launch (e.g., the first 0.005 seconds of flight) the high frame rate of the imager 105 permits the analysis of 2-10 frames The algorithm according to this embodiment determines the spin rate and 3D spin axis based on an estimation of a displacement between pixels in consecutive images of the sequence of images belonging to the ball as described below.

The knowledge of the 3D rotation vector is important in several applications. For example, determining the 3D rotation vector even when done using frames from the imager 105 representing only the first 0.005 seconds of the flight of the sports ball or less, this information used together with measured values for the launch angle, launch direction and ball speed, enable the system to calculate a full trajectory for the sports ball. The algorithm for the estimation of the 3D Spin Axis is referred to herein as the Ball Tracker (BT).

The BT works with optical or infrared images of a moving spinning sport ball to determine the 3D Spin Axis measurement. It is based on finding the exact displacement in pixels of each of a plurality of points on the ball from image to image in the sequence. For example, a pixel location is determined for each location on the ball in a first image and the displacement in pixels is calculated for the difference between the location of each point on the surface of the ball in the first image to its location in a second image. This is done by resorting to the estimation of the Dense Optical Flow (DOF), a vector field describing the movement pixel-by-pixel for every point on the ball represented by these pixels in two input images. It is based on recognition and tracking of every recognizable feature in the ball surface. For example, in the case of a golf ball, this could be the label of the ball or the dimples on the ball surface. That is, the pixel location of each spot on the ball in the first image is identified and the pixel locations for each of the spots on the ball in the second image are identified. The system then determines which of the positions on the ball in the second image were also shown in the first image. The displacement for each of these pixels that is shown in both images is calculated and this data is aggregated to assemble the vector field. Within this context, it is very important to have high resolution images acquired at a reasonably high fps, and with a fairly low exposure time to minimize blurring.

The main requirement is dictated by the maximum Spin Rate (SR) which can be observed. Given that the algorithm relies on an estimation of the pixel displacement, it is important that some recognizable ball features be observable in each sequential pair of frames analyzed. To guarantee that such a feature will be visible in consecutive frames, a feature that appears at the edge of the ball in a first frame of a consecutive pair can, at maximum, be at the center of the ball in next frame of the consecutive pair.

For example, a spin rate of a few thousand RPM (revolutions per minute) is typical for a golf shot, although this varies based on the type of club used. It is difficult to find examples of shots over 10,000 RPM. Therefore, a conservative threshold of 15,000 RPM can be used. With this maximum, the images would need to be acquired at a rate of at least 1,500 fps.

It may be preferable for 3-4 full revolutions of the ball to be available, which corresponds to a number of frames (e.g., between 15 and 30 frames). However, the lowest threshold for the algorithm is just 2 images. Additionally, the resolution of the images should be sufficient to correctly track the features in the ball. In an exemplary system, the imager 105 is configured so that, radius of the ball is at least 25 pixels throughout the portion of the flight of the ball to be recorded in images analyzed for this purpose. Given, for example, the known radius of a golf ball (0.04267 m), the (u, v) sensor coordinates in pixels can be converted into (x, y, z) real coordinates.

The algorithmic operations receive a number of images as input. The set of images can comprise consecutive images captured at a high frame rate. The images may be cropped to ensure that the ball is in substantially the same position and has substantially the same size in each of the images. The ball detection algorithm then generates a very accurate pixel and radius measure of the ball. A dense optical flow (DOF) is estimated for every pair of consecutive images.

The analysis of the dense optical flow (DOF) is then used to compute the 3D rotation vector which permits the spin rate (SR) and spin axis (SA), of the ball to be computed. The 3D rotation vector is computed in view of the geometry of the scene, including knowledge of the positions of the imager 105 and the ball 220. When calculated, the spin rate (SR) and spin axis (SA) are presented to the user, e.g., on a display 125.

According to the present disclosure, the system 100 is configured to enhance the determination of club delivery parameters. According to the flow chart 1100 shown in FIG. 11, the imager 105 captures an image sequence, the pre-impact sequence 410 in step 1110. Based on the post-impact sequence 420, the processor 120 is configured to determine ball launch parameters. Based on the localizer program 800, the processor 120 is configured to detect the club 230 in a pre-impact sequence 410 of images in step 1120. When performing image analysis, by using the object detector 810 to identify characteristic points on the club 230 for the pre-impact sequence 410 of images, the processor 120 determines a pre-impact travelling path data for the club 230 based on the identified characteristic points detected in the pre-impact sequence 410 of images. According to the present disclosure, the processor 120 may determine enhanced club data important to fully analyze the impact of the club and the ball. This is done by calculating the club delivery parameters from a mechanical impact model having the pre-impact travelling path data for the golf club as input. This makes it possible to increase the quality of the club data such as: Attack Angle, Dynamic Loft, Face Angle, Impact Height, and Impact Offset. Furthermore, it is possible to introduce new club data such as: Club Speed, Club Path, and Face to Path.

As understood by those skilled in the art Face to Path is a difference between the face angle and the club path. For a right-handed golfer, a negative face to path would represent a face angle that is “closed” to the path and a positive face to path would represent a face angle that is “open” to the path while a zero face to path represents a face angle and club path that have the same value. Face to path has been shown to be an important factor in determining the expected curvature (spin axis) of a golf shot in many instances. Assuming centered contact, the ball generally curves towards the face angle and away from the club path (if face to path is not equal to zero). Note that face to path is relative to the face angle and club path. It is not relative to the target line. A face to path of zero could be +5, 0, −5, or any other value relative to the club path. The zero face to path only represents the difference between where the club is moving horizontally (club path) and where the club face is pointed horizontally (face angle).

The mechanical impact model is based on laws of physics for collision between two objects. The momentum principle states that the total momentum of a system of objects is conserved if there are no external forces acting on the system. The law of conservation of momentum is a fundamental principle of physics that states that the total momentum of a closed system of objects (which has no net external forces acting on it) remains constant. Momentum is the product of an object's mass and velocity, and it is a vector quantity. Impulse is the change in momentum of an object over time and it is also a vector quantity.

Impact refers to the collision between two objects, the club 230 and the ball 220. Using information about a golf ball's initial linear and angular velocity (launch parameters) permits the calculation of the momentum of the golf ball. Under ideal conditions (ignoring energy lost in the collision), the post-impact momentum of the golf ball corresponds to the change in momentum for the golf club. A golf impact model used according to the present disclosure is based on finite-element and momentum-based impact model.

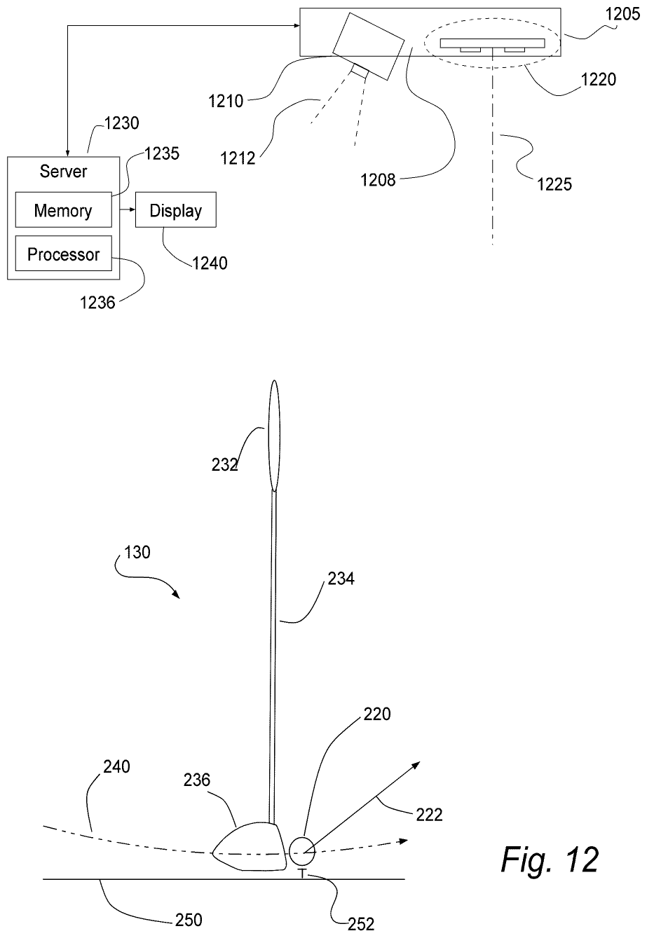

According to a further embodiment, the imager 105 discussed with reference to FIG. 2 has been replaced with a combined radar-imager tracking device 1205 illustrated in FIG. 12. The combined radar-imager tracking device 1205 of this embodiment includes an imager 1210 (e.g., a build-in imager) having, for example, qualities the same as those discussed above for the imager 105. The combined radar-imager tracking device 1205 of this embodiment is configured to be mounted on a ceiling or some other structure at a height above the scene to be tracked by the radar-imager tracking device 1205 although other positions that provide a field of view including the portions of the movement of the club head pre and post impact as well as the ball up to and immediately after impact are also possible as would be understood by those skilled in the art. In this example, the radar-imager tracking device 1205 is orientated so that its field of view (FOV) 1212 is facing downward toward the scene area 130.

In addition to the imager 1210, the combined radar-imager tracking device 1205 comprises at least one radar system 1220 (e.g., a doppler radar system) aimed at the scene area 130 to track the ball 220 and the club 230 as they move through the field of view of the radar system 1220 which overlaps with the field of view of the imager 1210. The radar system 1220 comprises a radar device having a transmitter emitting microwaves into a target volume, and one or more receivers configured to receive a radar signal reflected by objects in the target volume.

In some embodiments, the radar system 1220 is a radar device operating at approximately 10 GHz as a so-called X-band radar. In another embodiment, the radar system 1220 is a radar device operating at approximately 24 GHz as a so-called K-band radar. In yet other embodiments, the least one radar system 1220 has a first radar device operating at approximately 10 GHz and a second radar device operating at approximately 24 GHz. Alternatively or in addition, the system may employ various radars operating at any of 60 GHz, 77-82 GHz or 122 GHz as would be understood by those skilled in the art.

The K-band radar has in general a smaller antenna than X-band antenna and provides more precise target resolution. The K-band radar has a Higher Target Sensitivity and can detect smaller objects due to its higher sensitivity and higher-resolution imaging for better target identification, thanks to its shorter wavelength. The K-band radar operates at a higher frequency and with lower power output and is not as good to detect objects at long distances compared to the X-band radar. However, the K-band radar has a better resolution and better target identification for objects close to the radar sensor compared to an X-band radar.

The radar system 1220 has at least one receiver for detecting the Radial Velocity of the club head 236 and/or the ball 220. In one embodiment, the radar system 1220 operates in two frequency bands, and has in total four receivers providing two sets of receivers configured to receive radar signals transmitted at respective frequencies. The radar system 1220 according to this embodiment has two receivers for each frequency band, which permits the radar system 1220 to measure both the radial velocity as well as the distance to the club head 236 and/or the ball 220 at any point in time.

The transmitter and receiver antennas of the radar system 1220 are formed (e.g., printed) on the top side of a substrate with an appropriate dielectric constant. To improve isolation between the transmitter and receiver, electromagnetic band gap (EBG) structures may be employed. These structures minimize interference and enhance overall performance.

The housing component 1208 of the combined radar-imager tracking device 1205 encloses the radar system 1220 and the imager 1210. The combined radar-imager tracking device 1205 may include an internal data processing arrangement and may also communicate with a separate computer or server 1230 having a memory 1235, a processor 1236, and an optional display 1240. By ensuring that the radar system 1220 and the imager 1210 are mounted securely relative to each other, the radar system 1220 and the imager 1210 may be calibrated relative to each other from production so that users of the radar-imager tracking device 1205 do not need to recalibrate the radar-imager tracking device 1205 for each use, and this calibration may be referred to as an intrinsic calibration. This means that objects present in the field of view of the radar system 1220 and the imager 1210 will have a well-defined, known spatial relationship. When mounted, the radar system 1220 and the imager 1210 are positioned at an initial known position and orientation relative to one another and to the scene area 130, and the combined radar-imager tracking device 1205 is calibrated to the environment in which it is going to be used, and this calibration may be referred to as an extrinsic calibration.

The processor 1236 of this embodiment controls the combined radar-imager tracking device 1205 and time synchronizes the radar system 1220 and the imager 1210 to ensure that each radar data point and every imager data point have a common time base. The processor 1236 includes the hardware, firmware, and software necessary to provide the functionalities described in the present application regarding determining club delivery parameters as would be understood by those skilled in the art. In an exemplary embodiment, each of the radar system 1220 and the imager 1210 defines its own coordinate system relating to its recorded track data. The processor 1236 then defines a universal three-dimensional coordinate system into which the computer translates the tracking data from the respective radar coordinate system and imager coordinate system.

By synchronizing the imager 1210 (e.g., a full HD camera) with the radar system 1220, the system shown in FIG. 12 accurately captures the position of the ball 220 before impact. Furthermore, the path of the club head 236 is accurately tracked, too, with the combination of radar system 1220 and the imager 1210's providing highly precise knowledge of the club position in every frame—and in-between frames. This provides a high degree of precision for the system shown in FIG. 12, as the one or more built-in radar systems 1220 are synchronized with the imager 1210 for providing the most accurate analysis possible.

The system shown in FIG. 12 accurately measures club delivery, ball launch and full ball flight without the use of markers and accurately captures the impact location on the clubface without requiring modification of the clubface (i.e., the system can make all of these determinations when a user swings any unmodified club without the need for any additional or specialized markers on the clubface).

In one embodiment, the radar system 1220 generates at 40,000 samples per second to give precise data through and at the time of impact. The imager 1210 works together with the radar system 1220 to enhance the accuracy of clubhead tracking. The radar system 1220 will hereby assist the imager 1210 and processor 1236 by providing highly precise position data for the club head 236 when determining a pre-impact travelling path for the club 230 as discussed with reference to FIG. 3. In particular, radar data is used to determine the range/distance to the club head 236 and/or radial velocity of the club head 236 and/or the position and/or the radial velocity of the ball at one or more times. These data are combined with the data derived from the images produced by the imager 1210 regarding the angular position of various points on the club head 236 and/or the ball 220.

The radar system 1220 will assist the imager 1210 and processor 1236 in this process by providing highly precise position data for the club head 236 as input to the localizer program 800 as discussed with reference to FIG. 8, and as input for the method of enhancing determination of club delivery parameters according to one embodiment of the present disclosure as discussed with reference to FIG. 11

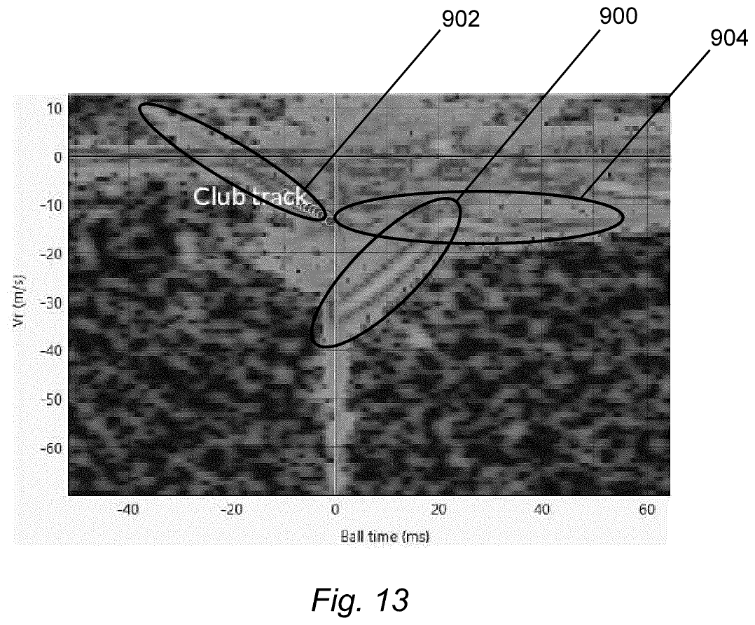

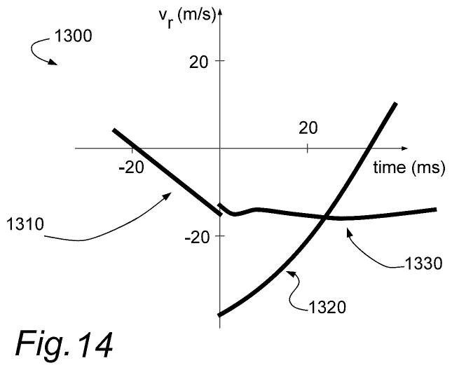

FIG. 13 shows a spectrogram of radar data corresponding to an exemplary pre-post impact time period for a golf swing while FIG. 14 is a graphical representation of the spectrogram of FIG. 13 simplified to show only impact related traces caused by movement of the club head 236 and the ball 220. The impact between the club head 236 and the ball 220 is represented as the vertical axis (time t=0). Traces in the spectrogram are caused by objects present in the scene viewed by the radar system 1220. Objects stationary relative to the radar system 1220, will cause traces at yr=0 m/s. Objects moving toward or away from the radar system 1220 will cause a frequency shift to higher or lower frequencies, respectively. The frequency shift is proportional to the velocity, vr. A first trace 902 in the spectrogram shown in FIG. 13 (trace 1310 in FIG. 14) is caused by the club head 236 approaching the ball 220. At impact, the ball 220 is launched off the clubface, and the reflections from the ball 220 are seen as a second trace 900 (trace 1320 in FIG. 14), while the further travel of the club head 236 after impact is seen as a third trace 904 (trace 1330 in FIG. 14). As indicated above, this radar data can be used to enhance the accuracy of the 3D tracking of the motion of the club head while the radar data regarding the ball can be analyzed in known manners to determine spin rate, spin axis, trajectory, etc. so that, when combined with similar data computed based on the 2D images, a highly accurate full trajectory of the ball can be computed based on this short period of post-impact time (e.g., 20 msec or less). As would be understood by those skilled in the art, the 3D tracking of the motion of the club head can be used, for example, to diagnose swing issues and assist in training the golfer to optimize the swing so that the resulting shot characteristics (e.g., aim, trajectory, spin rate and axis) approach the golfer's desired results.

Those skilled in the art will understand that various modifications may be made to the disclosed embodiments without departing from the teachings of this disclosure which is intended to be limited only by the claims appended hereto. For example, it is noted that the features of the various embodiments may be combined in any manner not specifically disclaimed or logically inconsistent with specific teachings of the disclosure.

1. A system configured to enhance determination of club delivery parameters, comprising:
an imager capturing a sequence of images of an area in which an impact between a golf club and a ball is to take place, the imager being configured to take a pre-impact series of images from an initial time pre-impact through a time of impact and a post-impact series of images from the time of impact through a final time after the time of impact; and
a processor configured to determine ball launch parameters based on a post-impact series of images, and is further configured to perform following operations:
identify predetermined characteristic points on the golf club in each of the pre-impact images;
determine pre-impact travelling path data for the golf club based on positions of the identified characteristic points in the pre-impact images; and
calculate club delivery parameters from a mechanical impact model based on the pre-impact travelling path data.

2. The system according to claim 1, wherein the processor is configured to apply the ball launch parameters as input to the mechanical impact model when calculating the club delivery parameters.

3. (canceled)

4. The system according to claim 1, wherein the processor is configured to determine a golf club type from the images provided by the imager, and wherein the processor is configured to provide the golf club type as input to the mechanical impact model together with the imager determined characteristics points to enhance the club delivery parameters.

5. (canceled)

6. The system according to claim 1, wherein the club delivery parameters include at least one of the following Club Speed, Club Path, and Face to Path.

7. The system according to claim 1, wherein the processor is configured to extract a first set of characteristic points for the golf club from each image in the pre-impact series of images and apply these data points in a swing model describing a path along which a club head travels towards impact with the ball.

8. The system according to claim 7, wherein the processor is configured to extract characteristic points on the golf club based on one of a contour of the club head and a pattern present on a surface of the club head.

9. The system according to claim 1, wherein the mechanical impact model used to calculate the club delivery parameters is based on at least one of pre-impact travelling path data for the golf club, the ball launch parameters determined by the processor from the post-impact series of images and a travelling path of the golf club after impact determined by the processor from the post-impact series of images.

10. The system according to claim 1, further comprising a radar system configured to provide position data to the processor for a club head in the series of images captured by the imager, wherein the radar system provides range data to the processor indicating a distance between the radar system and the golf club and/or the ball.

11. The system according to claim 10, wherein the radar system provides radial velocity data to the processor indicating radial velocity for the golf club and/or the ball.

12. The system according to claim 10, wherein the processor is configured to determine a pre-impact travelling path for the golf club based on the pre-impact series of images and the position data from the radar system for the club head in the pre-impact series of images.

13. The system according to claim 10, wherein the processor is configured to determine club delivery parameters based on the pre-impact series of images and the position data from the radar system for the club head in the pre-impact series of images.

14. A method for determining golf club delivery parameters, comprising:
capturing a series of images extending for a first predetermined time before an impact between a golf club and a ball through impact between the golf club and the ball for a second predetermined time after the impact between the golf club and the ball;
determining ball launch parameters based on the images corresponding to the second predetermined time;
identifying characteristic points on the golf club in the images of the pre-impact series of images;
determining pre-impact travelling path data for the golf club based the identified characteristic points detected in the pre-impact series of images; and
calculating club delivery parameters from a mechanical impact model based on pre-impact travelling path data for the golf club.

15. The method according to claim 14, wherein the mechanical impact model uses the ball launch parameters to calculate the club delivery parameters.

16-18. (canceled)

19. The method according to claim 14, further comprising extracting a first set of characteristic points on the golf club from at least two images in the pre-impact series of images and applying the first set of characteristic points in a swing model describing a path along which a club head travels toward impact with the ball.

20. The method according to claim 19, further comprising extracting the first set of characteristic points on the golf club based on one of a contour of the club head and a pattern present on a surface of the club head.

21. The method according to claim 14, further comprising calculating the club delivery parameters from the mechanical impact model based on the pre-impact travelling path data for the golf club, the ball launch parameters determined by a processor from a post-impact series of images and the travelling path of the golf club after impact determined by the processor based on the images corresponding to the second predetermined time.

22. (canceled)

23. A system for analyzing an impact between a golf club and a ball, comprising:
an imaging system having a field of view including an impact area in which impact between a golf club and a ball is anticipated, the imaging system generating a series of images throughout a time period extending from an initial time at least a first predetermined time before the impact through a final time at least a second predetermined time after the impact; and
a processor receiving the images from the imaging system and identifying in a plurality of pre-impact images taken from the initial time to a time of the impact a plurality of characteristic points on a selected portion of the golf club, the processor determining a location of each of the characteristic points in each of the plurality of pre-impact images and calculating a travel path of the selected portion of the golf club based on the locations of the characteristic points in the plurality of pre-impact images, the processor being configured to identify the ball in a plurality of post-impact images taken from the time of the impact through the final time and calculating a plurality of ball launch parameters based on the ball as identified in the plurality of post-impact images.

24. The system according to claim 23, wherein the processor is further configured to determine a plurality of club delivery parameters based on the calculated travel path of the selected portion of the golf club.

25-27. (canceled)

28. The system according to claim 23, wherein the processor is configured to determine a 3D spin axis of the ball based on a dense optical flow calculated by comparing positions in sequential ones of the post-impact images of selected points on a surface of the ball.

29. The system according to claim 28, wherein the imaging system includes only a single imager.

30. (canceled)
